(19) United States
(12) Patent Application Publication
(10) Pub. No.: US 2023/0133032 A1
(43) Pub. Date: May 4, 2023

(54) SECONDARY BATTERY

(71) Applicant: Samsung SDI Co., Ltd., Yongin-si (KR)

(72) Inventors: Jeong Soon SHIN, Yongin-si (KR); Kyu Gil CHOI, Yongin-si (KR)

(21) Appl. No.: 17/976,482

(22) Filed: Oct. 28, 2022

(30) Foreign Application Priority Data
Oct. 29, 2021 (KR) 10-2021-0146787

(51) Int. Cl. H01M 50/54; H01M 50/534

(52) U.S. Cl. CPC H01M 50/54; H01M 50/534

(57) ABSTRACT

A secondary battery includes an electrode assembly including a plurality of first electrode plates coated with a first active material, a plurality of second electrode plates coated with a second active material, and a separator between each of the first and second electrode plates. The first electrode plates include a plurality of first base material tabs respectively protruding therefrom, and the second electrode plates include a plurality of second base material tabs respectively protruding therefrom. The first base material tabs are gathered at one end of the electrode assembly in a thickness direction of the electrode assembly and coupled to each other, and the second base material tabs are gathered at the one end of the electrode assembly and coupled to each other.

### CROSS-REFERENCE TO RELATED APPLICATION

This application claims priority to and the benefit of Korean Patent Application No. 10-2021-0146787, filed on Oct. 29, 2021, in the Korean Intellectual Property Office (KIPO), the entire content of which is incorporated by reference herein.

### BACKGROUND

### 1. Field

Aspects of embodiments of the present disclosure relate to a secondary battery.

### 2. Description of the Related Art

Generally, a secondary battery is designed to be chargeable and dischargeable (i.e., rechargeable), different from a primary battery that is not designed to be chargeable. A secondary battery may have the form of a single battery or the form of a battery module in which a plurality of batteries are connected and bundled as a unit depending on the type of external device to be applied.

Recently, secondary batteries are being used in large transportation vehicles, such as hybrid vehicles, in addition to being used as power sources for small electronic devices, such as cell phones and notebook computers. Accordingly, the demand for high-output and high-capacity secondary batteries is rapidly increasing.

To supply sufficient power to an electronic device or transportation vehicle, the secondary battery has to be stably structured and designed.

The above-described information serves as the background of the present disclosure is for improving understanding of the background of the present disclosure. Thus, it may include information that does not constitute the prior art.

### SUMMARY

There is a need to reduce deterioration of cell stability due to problems such as tearing of an electrode plate of an electrode assembly or breakage of a base material tab during repeated charging and discharging of the secondary battery. Embodiments of the present disclosure provide a secondary battery having increased capacity by reducing a length of a bent area of an electrode tab.

An embodiment of the present disclosure provides a secondary battery including an electrode assembly. The electrode assembly includes a plurality of first electrode plates coated with a first active material, a plurality of second electrode plates coated with a second active material, and a separator disposed between each of the first electrode plates and each of the second electrode plates. The first electrode plates include a plurality of first base material tabs protruding from the plurality of first electrode plates, respectively, and the second electrode plates include a plurality of second base material tabs protruding from the plurality of second electrode plates, respectively. The first base material tabs are gathered at one end of the electrode assembly in a thickness direction of the electrode assembly and are coupled to each other, and the plurality of second base material tabs are gathered at the one end of the electrode assembly and are coupled to each other.

Each of the plurality of first base material tabs and each of the plurality of second base material tabs may be arranged at the same position, respectively, in a width direction of the electrode assembly and may be gathered at an upper end of the electrode assembly in a thickness direction of the electrode assembly.

A distance by which each of the first base material tabs and each of the second base material tabs protrude from the electrode assembly to be gathered with each other, respectively, may be about 1.7 mm or less.

The electrode assembly may have a thickness of about 5 mm or less.

The plurality of first base material tabs and the plurality of second base material tabs may extend in a direction perpendicular to a thickness of the electrode assembly to be gathered and coupled to each other without being bent in the thickness direction of the electrode assembly.

First and second lead tabs may be respectively coupled to each of an end of the plurality of first base material tabs and an end of the plurality of second base material tabs.

The first and second lead tabs may be respectively coupled to each of the first base material tab and the second base material tab by butt welding.

First and second insulating tapes may respectively cover area at where each of the first base material tab and the second base material tab is coupled to the first and second lead tabs.

The electrode assembly may be accommodated in a pouch including an upper end and a lower end, and the first and second insulating tapes may be arranged at a boundary at where the upper end and the lower end of the pouch are coupled to each other.

The lower end of the pouch may have an accommodation groove, and the accommodation groove may have a height corresponding to a height at which each of the first base material tab and the second base material tab is arranged with respect to the electrode assembly.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, explain aspects and features of the present disclosure.

In the drawings:

FIG. 1 is a schematic exploded perspective view of an electrode assembly in a secondary battery according to an embodiment;

FIG. 2 is a side view of the electrode assembly shown in FIG. 1;

FIG. 3 is a perspective view of the electrode assembly shown in FIGS. 1 and 2; and

FIG. 4 is a perspective view of the electrode assembly being accommodated in a pouch of the secondary battery according to an embodiment.

### DETAILED DESCRIPTION

The present disclosure may be embodied in many different forms and should not be construed as being limited to the embodiments set forth herein; rather, these embodiments are provided so that those skilled in the art thoroughly understand the present disclosure. In other words, these embodiments are provided so that this disclosure will be thorough and complete and will fully convey the scope of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Hereinafter, before describing an electrode assembly according to an embodiment with reference to the accompanying drawings, a general structure of an electrode assembly will be described.

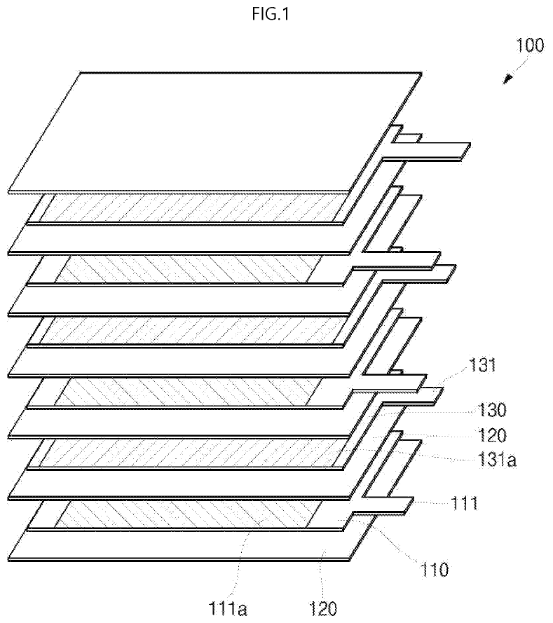

FIG. 1 is a schematic exploded perspective view of a structure of an electrode assembly in a secondary battery according to an embodiment.

As illustrated in FIG. 1, an electrode assembly 100 has a structure including a first electrode plate 110 provided (or formed) by applying a first active material 111a on each of both surfaces of a base material thereof, a separator 120, and a second electrode plate 130 provided (or formed) by applying a second active material 131a on each of both the surfaces of a base material thereof that are sequentially stacked. The separator 120 may be inserted (or arranged) between the first electrode plate 110 and the second electrode plate 130 to prevent a short circuit between the electrode plates. For example, the first electrode plate 110 may be a positive electrode plate, and the second electrode plate 130 may be a negative electrode plate. In other embodiments, however, these polarities may be reversed.

A first base material tab 111 and a second base material tab 131, on which the active material is not applied and which are to be electrically connected to an external electrode terminal, may be disposed on ends of one side of the first electrode plate 110 and one side of the second electrode plate 130, respectively. Structures and welding methods of the first base material tab 111 and the second base material tab 131 are the same, and for convenience, the first base material tab 111 will be described as a reference.

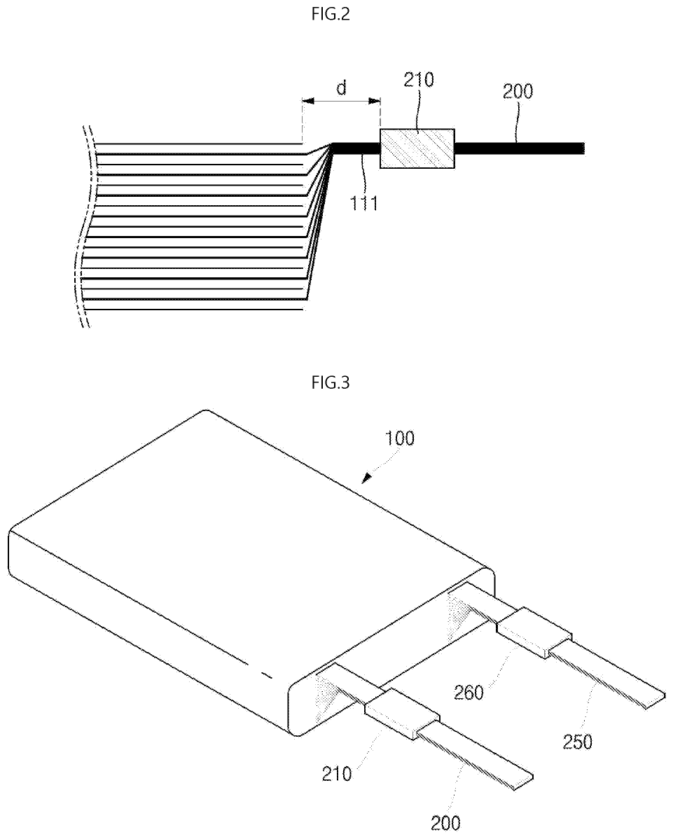

FIG. 2 is a side view of the electrode assembly 100 shown in FIG. 1, and FIG. 3 is a perspective view of the electrode assembly 100 shown in FIGS. 1 and 2.

Referring to FIG. 2, a plurality of first base material tabs 111 respectively protrude from the first electrode plates 110 of the electrode assembly 100 at regular intervals in a direction that is approximately perpendicular to a height (e.g., a stacking direction) of the electrode assembly 100. The first base material tabs 111 are gathered at an upper region of the electrode assembly 100 and are then coupled to each other by an insulating tape 210 at the concentrated portion of the first base material tabs 111. The first base material tabs 111 may be gathered at an upper end of the electrode assembly 100 and then welded to a lead tab 200. The insulating tape 210 may be provided to surround the welded portion of the first base material tabs 111 and the lead tab 200.

A length d of each of the first base material tabs 111 in a horizontal direction (e.g., a direction perpendicular to the thickness of the electrode assembly 100) in which the first base material tab 111 protrudes from each of the first electrode plate 110 (e.g., a proximal end) to the end thereof that is welded to the lead tab 200 (e.g., the distal end) may be about 1.7 mm or less. When the length d of the first base material tab 111 is about 1.7 mm or less, the first base material tab 111 may not need to be bent. For example, the gathered first base material tabs 111 may be welded (e.g., directly welded) to the lead tab 200 by, for example, butt welding. Therefore, when the length d of the first base material tab 111 is about 1.7 mm or less, the first base material tab 111 may be sufficiently rigid to reduce chances of bending, and thus, the welding with the lead tab 200 may be easily performed.

When the length d of the first base material tab 111 exceeds about 1.7 mm, the first base material tab 111 may sag, and thus, an additional structure, such as V-bending to offset (or compensate for) the sagging may be required. Therefore, according to embodiments of the present disclosure, the length d of the first base material tab 111 may be about 1.7 mm or less.

The total thickness of the electrode assembly 100 may be about 5 mm or less. When the thickness of the electrode assembly 100 is about 5 mm or less and the length d of the first base material tabs 111 in the horizontal direction is about 1.7 mm, the first base material tabs 111 may be easily concentrated (or gathered) at the upper end of the electrode assembly 100.

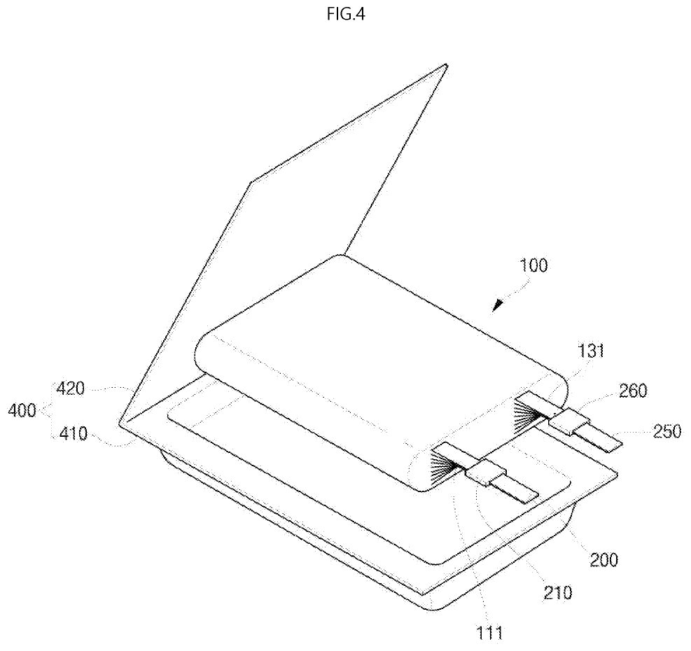

FIG. 4 is a view of the electrode assembly accommodated in a pouch of the secondary battery according to an embodiment.

Referring to FIG. 4, a coupling structure of the electrode assembly 100 and the lead tab 200 may be accommodated in a pouch 400. The pouch 400 may have a lower end (e.g., a lower portion) 410 that accommodates the electrode assembly 100 at an internal groove (or recess) around a bent area and an upper end (e.g., an upper portion) 420 folded at a boundary with the lower end 410 to seal with the lower end 410.

A depth of the groove in the lower end 410 may be defined to approximately correspond to the thickness of the electrode assembly 100. Thus, when the electrode assembly 100 is accommodated in the lower end 410, the first base material tab 111 and the second base material tab 131 may be disposed above the lower end 410 (e.g., may be on a plane above a plane defined by an upper edge of the lower end 410).

Insulating tapes 210 and 260 may be coupled to the first base material tab 111 and the second base material tab 131, which are disposed to correspond to an edge of the lower end 410. Thus, the insulating tapes 210 and 260 may prevent the first base material tab 111 and the second base material tab 131, as well as the lead tabs 200 and 250, which are respectively connected to the first base material tab 111 and the second base material tab 131, from directly contacting the pouch 400, thereby improving electrical insulation.

As described above, because the first base material tab 111 and the second base material tab 131 are disposed at the upper end of the electrode assembly 100 without separate bending, the lead tabs 200 and 250 coupled to the first base material tab 111 and the second base material tab 131 may extend to the outside of the lower end 410. In addition, because a space required for the first base material tab 111 and the second base material tab 131 is reduced or minimized, a space for accommodating the electrode assembly 100 with respect to the lower end 410 of the pouch 400 may be reduced or minimized. Thus, energy density of the secondary battery may be increased. Therefore, the secondary battery according to an embodiment may be easily manufactured while increasing its energy density.

According to an embodiment, the electrode tab may increase the capacity by reducing the length of the bent area to facilitate manufacturing.

The above-mentioned embodiments are merely examples, and thus, the present disclosure is not limited thereto. It will be understood by those of ordinary skill in the art that various changes in form and details may be made therein without departing from the spirit and scope of the present disclosure as defined by the following claims and their equivalents.

What is claimed is:

1. A secondary battery comprising an electrode assembly, the electrode assembly comprising a plurality of first electrode plates coated with a first active material, a plurality of second electrode plates coated with a second active material, and a separator between each of the first electrode plates and each of the second electrode plates,
wherein the plurality of first electrode plates comprises a plurality of first base material tabs protruding from the plurality of first electrode plates, respectively,
wherein the plurality of second electrode plates comprises a plurality of second base material tabs protruding from the plurality of second electrode plates, respectively,
wherein the plurality of first base material tabs is gathered at one end of the electrode assembly in a thickness direction of the electrode assembly and are coupled to each other, and
wherein the plurality of second base material tabs is gathered at the one end of the electrode assembly and are coupled to each other.

2. The secondary battery of claim 1, wherein each of the plurality of first base material tabs are at a same position in a width direction of the electrode assembly and are gathered at an upper end of the electrode assembly in the thickness direction of the electrode assembly, and
wherein each of the plurality of second base material tabs are at a same position in the width direction of the electrode assembly and are gathered at the upper end of the electrode assembly.

3. The secondary battery of claim 1, wherein a distance by which each of the first base material tabs protrudes from the electrode assembly is 1.7 mm or less.

4. The secondary battery of claim 3, wherein a distance by which each of the second base material tabs protrudes from the electrode assembly is 1.7 mm or less.

5. The secondary battery of claim 1, wherein the electrode assembly has a thickness of 5 mm or less.

6. The secondary battery of claim 1, wherein the plurality of first base material tabs extend in a direction perpendicular to the thickness direction of the electrode assembly and are gathered and coupled to each other without being bent in the thickness direction of the electrode assembly.

7. The secondary battery of claim 6, wherein the plurality of second base material tabs extend in the direction perpendicular to the thickness direction of the electrode assembly and are gathered and coupled to each other without being bent in the thickness direction of the electrode assembly.

8. The secondary battery of claim 1, further comprising:
a first lead tab coupled to an end of the plurality of first base material tabs; and
a second lead tab coupled to an end of the plurality of second base material tabs.

9. The secondary battery of claim 8, wherein the first lead tab is coupled to the plurality of first base material tabs, and the second lead tab is coupled to the plurality of second base material tabs by butt welding.

10. The secondary battery of claim 8, further comprising:
a first insulating tape covering an area at which the plurality of first base material tabs is coupled to the first lead tab; and
a second insulating tape covering an area at which the plurality of second base material tabs is coupled to the first lead tab.

11. The secondary battery of claim 10, further comprising a pouch accommodating the electrode assembly, the pouch comprising an upper end and a lower end,
wherein the first and second insulating tapes are at a boundary at where the upper end and the lower end of the pouch are coupled to each other.

12. The secondary battery of claim 11, wherein the lower end of the pouch has an accommodation groove, and
wherein the accommodation groove has a height corresponding to a height at which each of the coupled first base material tabs and the coupled second base material tabs are arranged with respect to the electrode assembly.
